(19) United States
(12) Patent Application Publication
(10) Pub. No.: US 2016/0010882 A1
(43) Pub. Date: Jan. 14, 2016

(54) DEHUMIDIFIER

(71) Applicant: LG ELECTRONICS INC., Seoul (KR)

(72) Inventors: Kunyoung LEE, Seoul (KR); Jongsu LEE, Seoul (KR); Sangyoun YOON, Seoul (KR)

(73) Assignee: LG Electronics Inc.

(21) Appl. No.: 14/793,826

(22) Filed: Jul. 8, 2015

(30) Foreign Application Priority Data
Jul. 9, 2014 (KR) 10-2014-0086333

(51) Int. Cl. F24F 3/14; F24F 13/20; F16H 19/04; F25D 21/14; B01D 53/26; A47B 81/00

(52) U.S. Cl. CPC F24F 3/1405; B01D 53/265; A47B 81/00; F16H 19/04; F25D 21/14; F24F 13/20; F24F 2003/1446

(57) ABSTRACT

A dehumidifier may be provided that includes a water tank, a tank drawer, a frame, a main guide and a sub guide. The main guide on first and sides of the frame to guide the tank drawer when being moved inward and when being moved outward. The sub guide on the first and second sides of the frame to accommodate a rotation protrusion that protrudes from each of first and second side surfaces of the tank drawer.

### CROSS-REFERENCE TO RELATED APPLICATION(S)

The present application claims priority under 35 U.S.C. 119 and 35 U.S.C. 365 from Korean Patent Application No. 10-2014-0086333, filed Jul. 9, 2014, the subject matter of which is incorporated herein by reference.

### BACKGROUND

1. Field

Embodiments may relate to a dehumidifier.

2. Background

Dehumidifiers are apparatuses that suction wet humid air within an indoor space into a case and allow the air to pass through a heat exchanger including a condenser and an evaporator, thereby reducing humidity. The dehumidified air may be discharged again into the indoor space to reduce humidity within the indoor unit.

A dehumidifier may absorb heat from surrounding air by evaporating a liquid refrigerant in the evaporator. The evaporator may decrease in temperature while the refrigerant is evaporated, and thus the air passing through the evaporator may also decrease in temperature. Since the surrounding air of the evaporator decreases in temperature, moisture contained in the air may be condensed to form dew on a surface of the evaporator. The dehumidified air may be discharged into the indoor space to reduce the humidity within the indoor space.

Large-scale and multifunctional dehumidifiers may be provided to improve dehumidifying performance and user's convenience. Thus, high-capacity and large-scale humidifiers may be preferred.

A dehumidifier in which a lower portion of an evaporator has a basket shape to collect and store condensed water, is disclosed in Korean Patent Publication No. 10-2005-0083417, the subject matter of which is incorporated herein reference. In the dehumidifier having the above-described structure, if a preset amount (or more) of water is collected in the basket, a user may withdraw the basket to discard water within the basket and then mount the basket again.

However, as the dehumidifier increases in capacity, the basket for storing the collected water may also increase in capacity. When the basket is withdrawn because the basket is fully filled with water, it may be difficult to withdraw the basket due to a weight of the collected water.

The dehumidifier may include a main body including an air suction part and a discharge part, a heat exchanger provided inside the air suction part and heat-exchanged with indoor air to perform a dehumidification operation, a fan assembly disposed at a front side of the heat exchanger to forcibly blow the indoor air, and a water tank disposed on a side of the heat exchanger to collect condensed water.

The condensed water, condensed in the evaporator, may be stored in a drain fan and then introduced into the water tank along a predetermined guide structure. When a predetermined amount (or more) of water is stored in the water tank, the water tank may be separated to drain the water within the water tank.

Since the water tank is disposed inside the main body, a separate water tank cover for covering the water tank may be provided. When the water tank cover is provided, the user may have to open the water tank cover so as to separate the water tank from the main body and then withdraw the water tank.

To solve the above-described limitation, a structure of a dehumidifier in which a water tank is rotatably mounted on a recessed water tank mounting part of a main body, and the water is withdrawn when the water tank rotates by manipulation of a water tank handle disposed on a front surface of the water tank is disclosed in Korean Patent Publication No. 10-2013-0138478, the subject matter of which is incorporate herein by reference.

However, in this structure, a portion of the water tank, in which water is collected, has to have a small capacity so as to rotate without interfering when the water tank is mounted on the water tank mounting part. Since a space in which the water tank rotates without interfering is further provided in the main body, spatial efficiency may deteriorate.

Additionally, if the water tank rotates when the water is fully filled into the water tank, the water tank may easily fall down or have a difficulty in manipulating because a separate restriction structure is not provided.

### BRIEF DESCRIPTION OF THE DRAWINGS

Arrangements and embodiments may be described in detail with reference to the following drawings in which like reference numerals refer to like elements and wherein:

FIG. 1 is a front perspective view of a dehumidifier according to an embodiment;

FIG. 2 is a rear perspective view of the dehumidifier;

FIG. 3 is an exploded perspective view of the dehumidifier;

FIG. 4 is an exploded perspective view of the housing assembly;

FIG. 5 is an exploded perspective view of a coupling structure between a top cover assembly;

FIG. 6 is an exploded perspective view of the top cover assembly;

FIG. 7 is an exploded perspective view of a coupling structure of the side deco;

FIG. 8 is an exploded perspective view of a coupling structure of a PCB assembly;

FIG. 9 is an exploded perspective of a coupling structure of a tank drawer;

FIG. 10 is a side view of a structure of a guide assembly for guiding insertion/withdrawal of a water tank assembly;

FIG. 11 is a perspective view of a water tank;

FIG. 12 is a side view of the dehumidifier before the water tank assembly is withdrawn;

FIG. 13 is a side view of the dehumidifier when the water tank assembly is withdrawn;

FIG. 14 is a side view of the guide assembly when the water tank assembly is withdrawn;

FIG. 15 is a side view of the dehumidifier when the water tank assembly is tilted after being withdrawn;

FIG. 16 is a side view of the guide assembly when the water tank assembly is tilted after being withdrawn;

FIG. 17 is a perspective view illustrating a state when the water tank is separated from the water tank assembly;

FIG. 18 is an exploded perspective of a coupling structure of a tank drawer according to an embodiment;

FIG. 19 is a side view of a guide assembly before a water tank assembly according to an embodiment;

FIG. 20 is a side view of the guide assembly when the water tank assembly is withdrawn; and

FIG. 21 is a side view of the guide assembly when the water tank assembly is tilted after being withdrawn.

### DETAILED DESCRIPTION

Reference may now be made in detail to embodiments of the present disclosure, examples of which are illustrated in the accompanying drawings. The technical scope of the embodiments may fall within the scope of this disclosure, and addition, deletion, and modification of components or parts are possible within the scope of the embodiments.

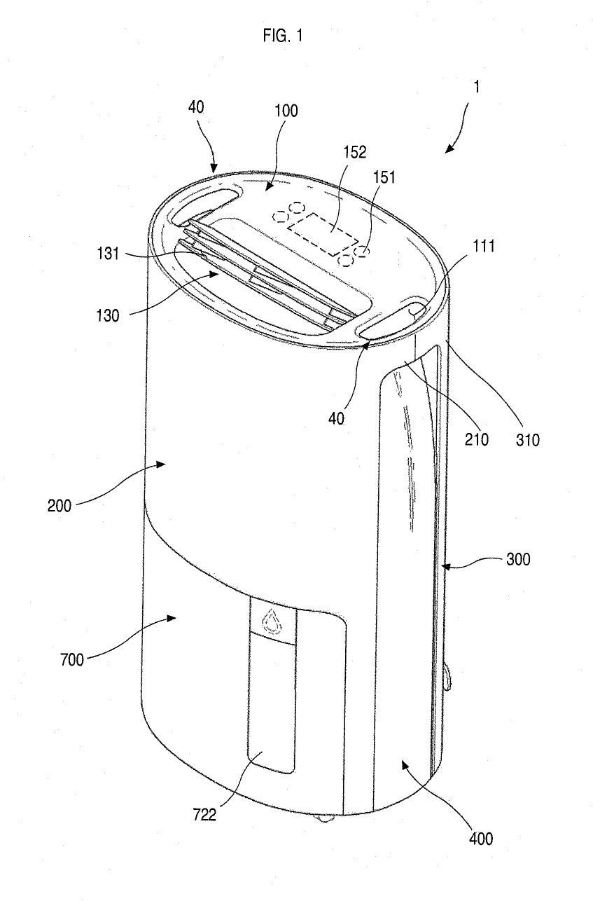

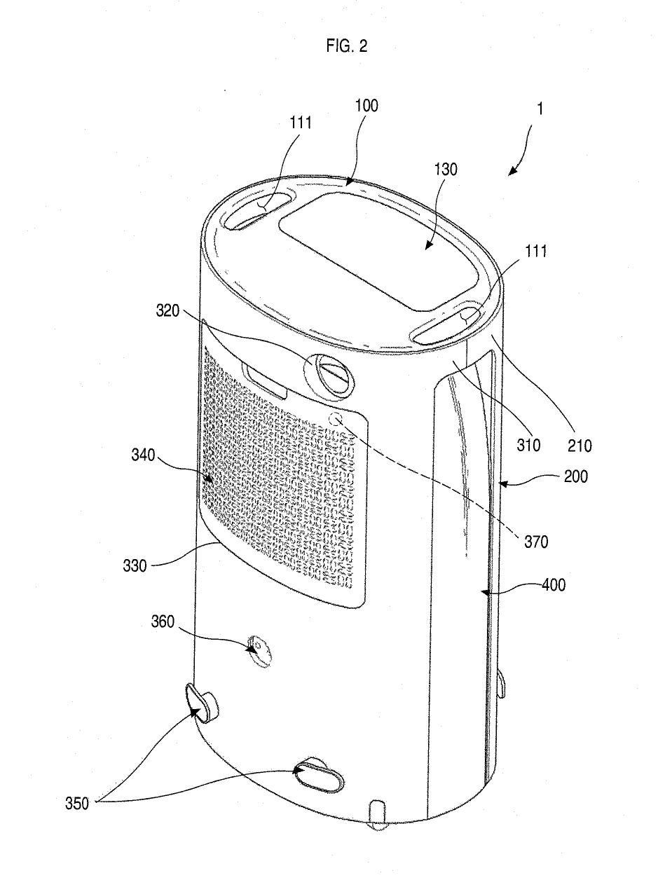

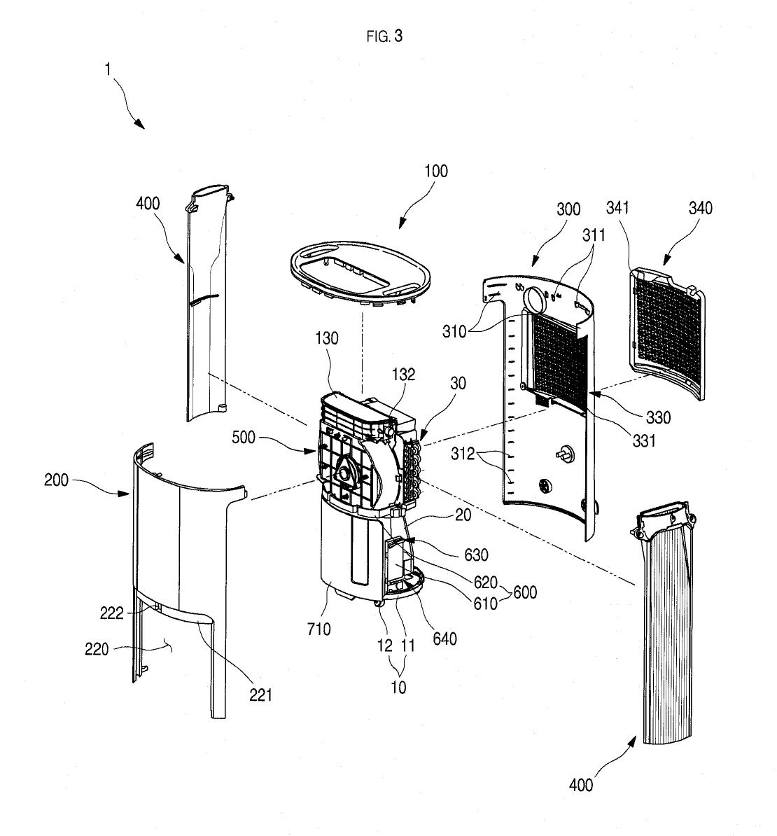

FIG. 1 is a front perspective view of a dehumidifier according to an embodiment. FIG. 2 is a rear perspective view of the dehumidifier. FIG. 3 is an exploded perspective view of the dehumidifier. Other embodiments and configurations may also be provided.

Referring to FIGS. 1 to 3, a main body defining an outer appearance of a dehumidifier 1 may have a generally circular cross-section when viewed from an upper side and a cylindrical shape having a predetermined height.

The dehumidifier 1 may have an outer appearance that is defined by a top cover assembly 100 defining a top surface, a base pan assembly 10 defining a bottom surface, front and rear cases 200 and 300 defining front and rear surfaces, and a side deco 400 defining a portion of each of both side surfaces.

The top cover assembly 100 may define a top surface of the dehumidifier 1, and may have an oval shape. A handle hole 111 may be provided into which a hand of a user may be inserted to grasp the dehumidifier 1. The handle hole 111 may be defined at each of both sides of the top cover assembly 100.

A louver 130 may be disposed at a front portion of the top cover assembly 100. The louver 130 has a plurality of discharge holes 131 through which air dehumidified within the dehumidifier 1 is discharged. The louver 130 is rotatably mounted on the top cover assembly 100. The louver 130 may rotate to expose the discharge holes 131 thereof when the dehumidifier 1 operates. On the other hand, when the dehumidifier 1 is not operating, the louver 130 may rotate and does not expose the discharge holes 131 thereof. When dehumidifier 1 is not operating, the louver 130 may form the same plane as the top cover assembly 100 to define the outer appearance of the top surface of the dehumidifier 1. The louver 130 may rotate by a motor 132. When the dehumidifier 1 operates, the louver 130 may automatically rotate to open the discharge holes 131, thereby adjusting a discharge direction of the air.

A manipulation part 151 may be on the top cover assembly 100. The manipulation part 151 may be manipulated by the user to manipulate the dehumidifier 1. The manipulation part 151 may be provided in a rear space of the louver 130. The manipulation part 151 may be manipulated by the user and confirmed through the top surface of the top cover assembly 100. The manipulation part 151 may include a capacitive-type touch sensor, a button, and/or a switch. A display part 152 for displaying an operation state of the dehumidifier 1 may be provided on one side adjacent to the manipulation part 151.

The base pan assembly 10 may include a base pan 11 defining the bottom surface of the dehumidifier 1 and a wheel 12 mounted on the base pan 11. The base pan 11 may provide a surface on which a compressor 20, which is main component of the dehumidifier 1, and a plurality of components are disposed. A plurality of reinforcing ribs that cross each other are disposed on the base pan 11 to prevent the base pan 11 from being deformed or damaged even though the plurality of components are provided on the base pan 11. The whole shape of the base pan 11 may have an oval shape to correspond to that of the top cover assembly 100.

A wheel 12 may be disposed on a bottom surface of the base pan 11 to allow the dehumidifier 1 to easily move. More particularly, when the user grasps the handle 40 (of the dehumidifier 1) to move the dehumidifier 1, the wheel 12 may allow the user to easily push or pull the dehumidifier 1.

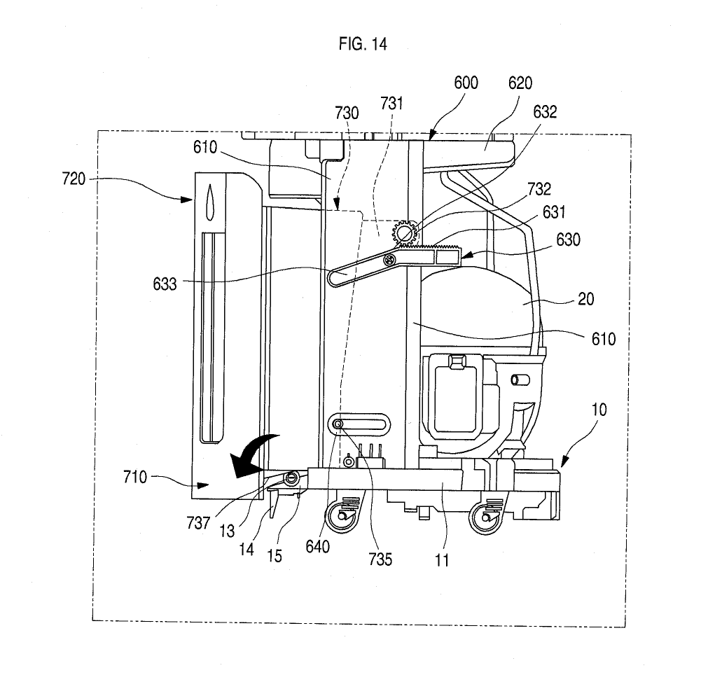

A base roller 13 (FIG. 14) may be disposed on a front end of a top surface of the base pan 11. The base roller 13 may contact a bottom surface of a tank drawer 710 and may then be rolled when the tank drawer 710 (into which a water tank 800 is accommodated) is withdrawn forward (or moved forward). When the tank drawer 710 is completely withdrawn, a weight center of the tank drawer 710 is at a relatively front side when compared to the base roller 13. Thus, the tank drawer 710 may be tilted.

The front case 200 and the rear case 300 define the front and rear outer appearances of the dehumidifier 1. The front case 200 and the rear case 300 may be formed of plate-shaped materials, and may be coupled to the top cover assembly 100 and the bottom surface of the base fan 11, respectively. The front case 200 and the rear case 300 may have curvatures corresponding to circumferences of the top cover assembly 100 and the base pan 11, respectively.

A front extension part 210 extending backward may be disposed on each of both left and right sides (first and second sides) of an upper end of the front case 200. The front extension part 210 may contact a rear extension part 310 of the rear case 300 to connect the front case 200 to the rear case 300. The front extension part 210 may be coupled along a circumference of the top cover assembly 100.

A tank mounting part 220, on which the water tank assembly 700 is disposed, may be provided below the front case 200. The tank mounting part 220 may be opened to correspond to a shape of the tank drawer 710 constituting the water tank assembly 700. A stepped part 221 may extend downward from an upper end of the tank mounting part 220. When the tank drawer 710 is closed, the tank mounting part 220 may contact a bottom surface of the tank drawer 710. A latch hole 222, through which a locker 721 protruding from the tank drawer 710 is inserted or withdrawn, may be defined in a center of the stepped part 221.

The top cover coupling parts 311, coupled to the top cover assembly 100, are provided on an upper portion of a back surface of the front case 200. The top cover coupling parts 311 are disposed above the front case 200 and the rear case 300. The top cover coupling parts 211 may be provided in plurality at a predetermined distance so that the top cover coupling parts 311 are hooked along a circumference of the top cover assembly 100. The top cover coupling part 311 may have the same structure and shape as those of the front and rear cases 200 and 300 except for a position thereof.

A plurality of deco coupling parts 312 may be disposed along both ends of the back surface of the front case 200. The deco coupling parts 312 may be coupled to the side deco 400 and may be vertically spaced a predetermined distance from each other along a side end of the front case 200. The deco coupling parts 312 may be coupled to match deco coupling holes defined in the side deco 400, thereby coupling the front case 200 to the side deco 400.

The deco coupling parts 312 may be disposed on both left and right sides of the front case 200. The deco coupling parts 312 may have the same structure and shape except for its position. The deco coupling parts 312 may be disposed to have the same structure and shape on the front case 200 and the rear case 300. Thus, all of the front case 200 and the rear case 300 may have structures that are coupled to and fixed to the side deco 400.

The rear case 300 may define a rear outer appearance of the dehumidifier 1, and may have a shape corresponding to that of the front case 200. A rear extension part 310 may be disposed on each of both left and right ends of an upper portion of the rear case 300 and coupled to the front extension part 210.

An accessory hole 320 may be defined in an upper portion of the rear case 300. The accessory hole 320 may be a hole through which an accessory connection part passes. That is, the accessory hole 320 may be opened in a shape corresponding to that through which the accessory connection part 570 passes to protrude to the outside.

A suction grill part 330 may be disposed below the accessory hole 320. The suction grill part 330 has a rectangular shape that is recessed inward. The suction grill part 330 has a shape corresponding to that of a heat exchange module 30. The suction grill part 330 has a plurality of suction holes 331 so that external air is introduced into the dehumidifier 1.

A grill cover 340 is mounted on a recessed outer portion of the suction grill part 330. The grill cover 340 covers a recessed space of the suction grill part 330 and forms the same line as an outer surface of the rear case 330. A plurality of holes may be defined in the grill cover 340 so that air flows through the suction grill part 330.

The grill cover 340 may be detachably disposed on the suction grill part 330. A filter assembly 341 may be mounted between the suction grill part 330 and the grill cover 340. The filter assembly 341 may filter foreign substances of the air introduced through the suction grill part 330. The filter assembly 341 may be fixed to the suction grill part 330 or fixed to a rear surface of the filter assembly 341 as shown in FIG. 3.

A code cord fixing hole 360 and a cord holder 350 may be provided below the suction grill part 330. The cord holder 350 may be provided in a pair in each of both left and right sides. The cord holder 350 protrudes backward from the rear case 300 so that a power line for supplying a power to the dehumidifier 1 is wound around the pair of cord holders 350 and thereby stored. The protruding end of the cord holder 350 may extend outward.

The code cord fixing hole 360 is disposed above the cord holder 350. The code cord fixing hole 360 may be disposed at a central portion and recessed in a space corresponding to a socket so that a plug at an end of the power line is inserted. Thus, the power line is wound around the cord holder 350, and then the plug is inserted into the code cord fixing hole 360 to effectively fix and store the power line.

The top cover coupling part 311 and the deco coupling part 312, which have the same shape as that of the front case 200, may be disposed on an inner surface of the rear case 300. The top cover coupling part 311 and the deco coupling part 312 may have the same shape and function as the front case 200 except for their position.

The top cover assembly 100 and the base pan 11 may be fixedly mounted on lower ends of the front case 200 and the rear case 300, respectively. The side deco 400 may be mounted between the front case 200 and the rear case 300 to define the whole outer appearance of the dehumidifier 1.

A housing assembly 500 may include a blowing fan 540 and the motor 530 and the heat exchange module 30 heat-exchanged with the suction air may be disposed in an upper portion inside the front case 200 and the rear case 300. Electronic components including a frame 600 supporting the housing assembly 500 and the heat exchange module 30, the water tank assembly 700 for collecting condensed water generated in the heat exchange module 30, and a compressor connected to the heat exchange module 30 to compress a refrigerant may be disposed in a lower portion inside the front case 200 and the rear case 300.

The frame 600 may be mounted to a center of the base pan 11. The frame 600 includes a vertical part 610 extending vertically and a horizontal part 620 extending horizontally from an upper end of the vertical part 610.

The vertical part 610 may partition a lower space of the dehumidifier 1 in a front/rear direction to define a front space in which the water tank assembly 700 is provided and a rear space in which the electronic components (including the compressor 20) are provided. A main guide 630 and a sub guide 640 are disposed on both left and right sides (first and second sides) of the vertical part 610 so that the tank drawer 710 is slidably inserted or slidably withdrawn.

The horizontal part 620 may partition the inner space of the dehumidifier 1 into upper and lower spaces so that the housing assembly 500 and the heat exchange module 30 are seated. A passage for guiding the condensed water (generated at the heat exchange module 30) to the water tank 800 is defined in the horizontal part 620.

A specific shape of the frame 600 may be described in more detail.

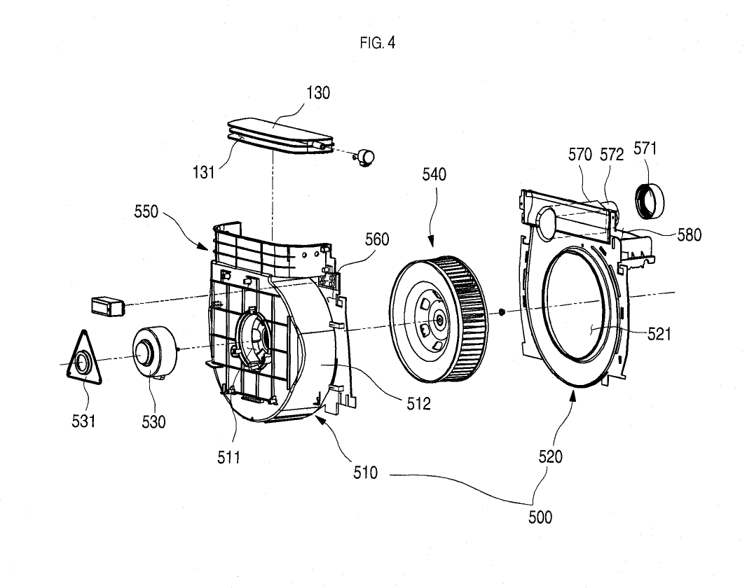

FIG. 4 is an exploded perspective view of the housing assembly.

As shown in FIG. 4, the motor 530 and the blowing fan 540 for forcibly blowing air are mounted on the housing assembly 500. The housing assembly 500 is seated on an upper portion of the horizontal part 620 (of the frame 600). The housing assembly 500 includes a housing case 510 and a housing cover 520. The housing cover 520 and the housing case 510 may be coupled to each other to form a space in which the blowing fan 540 is accommodated and a space through which air flows.

The housing case 510 may have a shape in which a rear surface is opened to form the space in which the blowing fan 540 is accommodated, and a top surface is opened to allow the louver 130 to be mounted. The opened entire rear surface of the housing case 510 may be covered by the housing cover 520 having a shape corresponding thereto.

A motor accommodation part 511 for accommodating the motor 530 may be recessed from a front surface of the housing case 510. A rotation shaft of the motor 530 may pass through the housing case 510 to extend inward. A BLDC motor having a relatively long life-cycle and easily controlled in rotation rate may be used as the motor 530 for rotating the blowing fan 540. The motor 530 may be fixedly mounted on the housing case 510 by the motor bracket 531.

The blowing fan 540 that axially suctions air to radially discharge the suctioned air may be disposed in an inner space of the housing case 510. A sirocco fan having less noises and superior blowing performance may be used as the blowing fan 540. Air introduced into the housing case 510, by the rotation of the blowing fan 540, may flow along the inner surface of the housing case 510, and may then be discharged to the outside through the louver 130.

The inner surface of the housing case 510 may have a curved shape to improve flow of the air. A curved part 512 having a curvature corresponding to that of the inside may be disposed on one side surface of both side surfaces of the housing case 510. The curved part 512 may be formed from a lower end of the housing case 510 to a louver mounting part 550 on which the louver 130 is provided. A capacitor mounting part 560, on which a capacitor 595 is mounted, may be exposed between the curved part 512 and the louver mounting part 550. That is, the curved part 512 (of the housing case 510) may be formed along the curvature of the inner surface of the housing case 510 to form the capacitor mounting part 560.

The housing cover 520 may have a plate shape corresponding to that of the housing case 510. An orifice 521 defining a passage through which the air is suctioned may be opened in the housing cover 520. The accessory connection part 570 may be disposed on a portion of an upper portion of the housing cover 520. The accessory connection part 570 may have a shape to allow the inside of the housing case 510, on which the louver 130 is mounted, to communicate with an external space. The accessory connection part 570 may have an end with a shape corresponding so that the end passes through the accessory hole 320 and is exposed to the outside.

A connection part cap 571 may be detachably mounted on the end of the accessory connection part 570. The connection part cap 571 may cover the opened end of the accessory connection part 570 to prevent air from leaking to the outside. A rotation coupling part 572 may be disposed on an end of the accessory connection part 570 to couple the connection cap 571 to the accessory connection part 570. The connection cap 571 may rotate to detach the rotation coupling part 572 from the accessory connection part 570. After the connection cap 571 is separated, an extension hose or other accessories may be simply coupled to the rotation coupling part 572 through rotation manipulation.

A control box mounting part 580 may be disposed above the orifice 521. The control box mounting part 580 may extend backward from a back surface of the housing cover 520 to vertically partition the space in which the heat exchange module 30 is disposed. A control box 590 for controlling operation of the dehumidifier 1 may be mounted on the control box mounting part 580.

The control box mounting part 580 may be disposed at a position corresponding to that of the capacitor mounting part 560. Thus, the capacitor 595 may be disposed at the same height as the control box 590 and may be connected to the control box 590 at the shortest distance.

The heat exchange module 30 may be disposed below the control box mounting part 580. The heat exchange module 30 may be seated on the horizontal part 620 of the frame 600, and may have a size corresponding to a space defined between the control box mounting part 580 and the horizontal part 620.

The heat exchange module 30 may be connected to the compressor 20. The heat exchange module 30 may include an evaporator 31 heat-exchanged with air introduced into the dehumidifier 1 and a condenser 32 connected to the evaporator 31 to allow the refrigerant to flow therethrough and heat-exchanged with air passing through the evaporator 31.

The evaporator 31 and the condenser 32 are installed in parallel and may be disposed in a front/rear direction. The air heat-exchanged with the refrigerant while passing through the evaporator 31 may be heat-exchanged again with the refrigerant while passing through the condenser 32.

The refrigerant supplied to the compressor 20 may flow toward the condenser 32 through the evaporator via an expansion unit, and may then be introduced again into the compressor 20. The air suctioned into the dehumidifier 1 may be introduced into the housing assembly 500 via the orifice 521 while successively passing through the evaporator 31 and the condenser 32, and may then be discharged again to the outside.

The indoor air suctioned through the suction hole 331 may be heat-exchanged while passing through the evaporator 31 to decrease in temperature. Thus, moisture contained in the air may be liquefied and separated from the air to generate dehumidified air.

The air separated from the moisture while passing through the evaporator 31 may be heated while passing through the condenser 32 and then dried. The dried air may be discharged into the external space of the dehumidifier 1 through the discharge hole 131 in the state of the dehumidified air from which the moisture is removed.

As described above, since the evaporator 31 and the condenser 32 are arranged in parallel, the air passing through the suction hole 331 may be dehumidified while passing through the evaporator 31 and heated (dried) while passing through the condenser 32.

The moisture separated from the air while passing through the evaporator 31 may be liquefied to change to a liquid state. The phase-changing condensed water may flow along a drain passage 621 defined in the horizontal part 620 (of the frame 600) and may then be collected into the water tank 800.

A lower end of the condenser 32 may be inserted into the horizontal part 620, and the condensed water may flow via an area on which the condenser is mounted. When at least a portion of the lower end of the condenser 32 is accommodated into the inner space of the drain passage 621, the condenser 32 may be cooled by the condensed water flowing along the drain passage 621 to improve efficiency of the condenser 32.

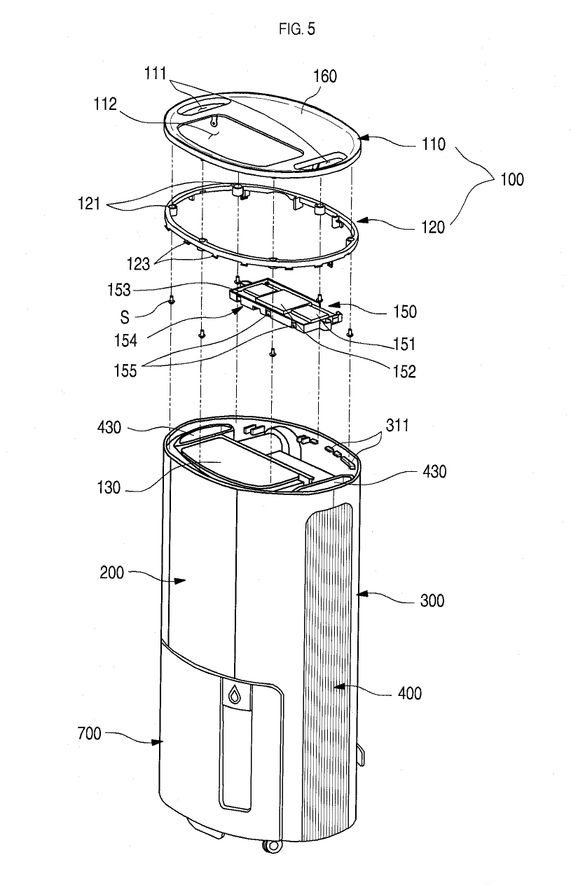

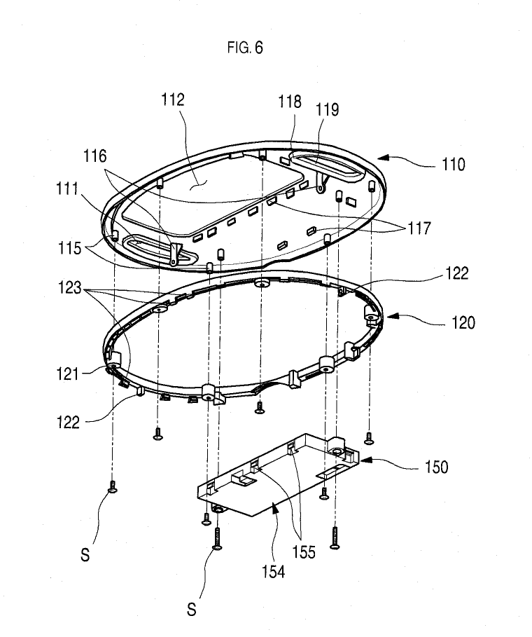

FIG. 5 is an exploded perspective view illustrating a coupling structure between a top cover assembly and a main body. FIG. 6 is an exploded perspective view of the top cover assembly.

The top cover assembly 100 may be described with reference to FIGS. 5 and 6. The top cover assembly 100 may include a cover plate 110 and a cover frame 120.

The cover plate 110 may define an outer appearance of the top surface of the dehumidifier 1. The cover plate 110 may have a plate shape and an oval shape corresponding to the whole shape of the top surface of the dehumidifier 1.

A handle hole 111, in which a handle 40 of the dehumidifier 1 is formed, may be punched in each of both left and right side of the cover plate 110. The handle hole 111 is configured so that the hand of the user is inserted to grasp both sides of the dehumidifier 1. The handle hole 111 may have a size corresponding to that of an opening 430 of the side deco 400.

A louver mounting hole 112, in which the louver 130 is disposed, may be in the cover plate 110. The louver mounting hole 112 may have a size and shape corresponding to those of the louver 130 in the state where the louver 130 is closed. A top surface of the louver 130 may cover the louver mounting hole 112 in the state where the louver 130 is closed to form the same plane as the cover plate 110. When the louver 130 is opened, the louver mounting hole 112 may also be opened.

A display part window may be disposed at a rear side of the louver mounting hole 112. The display part window may allow the display part 152 to be exposed. The display part window may be opened in a shape corresponding to the display part 152 or may be formed of a transparent material to cover the opened portion. A printing part for informing a position of the manipulation part 151 may be further disposed on the cover plate 110 adjacent to the display part window. The printing part may be touched to manipulate the manipulation part.

Cover coupling parts 115 may be spaced a predetermined distance from each other along a circumference of a bottom surface of the cover plate 110. The cover coupling part 115 may be a portion to which a screw S passing through the cover frame 120 is coupled. The cover plate 110 may be coupled to the cover frame 120 through the cover coupling part 115.

A cover fixing part 116, coupled to the housing assembly 500 by using the screw S, may extend downward from each of both sides of a bottom surface of the cover plate 110. The cover fixing part 116 may contact one side of a control box mounting part 580 of the housing cover 520, and the cover fixing part 116 may be fixed by the screw S to allow the top cover assembly 100 to be fixedly mounted.

A manipulation unit fixing member 117, for fixedly mounting a manipulation unit 150, may be disposed on the bottom surface of the cover plate 110 corresponding to the manipulation part 151 and the display part 152. The manipulation unit fixing member 117 may have a rib shape. The manipulation unit fixing member 117 may be provided in plurality, and thus the plurality of manipulation unit fixing members 117 may be disposed at a predetermined distance along a circumference of the manipulation unit 150. A hook may be disposed on an end of the manipulation unit fixing member 117 to restrain the circumference of the manipulation unit 150 by the manipulation unit fixing member 117 so that the manipulation unit 150 is fixedly mounted on the back surface of the cover plate 110.

The manipulation unit 150 may include the display unit 152 and the manipulation part 151. A display and a plurality of switches (or sensors) may be disposed on one PCB 591 (or circuit board) to form the display part 152 and the manipulation part 151 so that the user manipulates an operation of the dehumidifier 1 or informs an operation state of the dehumidifier 1 to the outside. Alternatively, the manipulation unit 150 may be constituted by only the manipulation part 151, and the display part 152 may be independently provided as a separate part.

The manipulation unit 150 may further include a board case 154 accommodating the PCB 153. A case hook part 155 in which the manipulation unit fixing member 117 is inserted to pass therethrough and is hooked thereto, may be provided on a circumference of the board case 154.

A handle hole rib 118 (extending downward) may be disposed along a circumference of the handle hole 111. The handle hole rib 118 may have a shape corresponding to an upper end of the side deco 400 so that the handle hole rib 118 and the upper end of the side deco 400 are coupled to each other to match each other. A rib stepped part 119 having a stepped portion may be disposed on the handle hole rib 118 to match a deco stepped part 431 disposed on the upper end of the side deco 400. The side deco 400 may be fixed while being maintained in position on the cover plate 110 to form the handle 40.

A circumference 160 may be disposed around a top surface of the cover plate 110. The circumference 160 may have an upward protruding shape. The inside of the circumference 160 may have a roundly recessed shape. A chrome line may be printed on the circumference 160 of the cover plate 110 as if a member formed of a separate chrome material is coupled to the cover plate 110. The cover plate 110 may be injection-molded by using an in-mold labeling (IML) manner. The cover plate 110 may be injection-molded by using a plastic material. A chrome film may be printed on the circumference 160.

The cover plate 110, molded through the above-described manner, may be unnecessary to having a coupling structure of a separate component formed of a chrome material. When the cover plate 110 is molded, the cover plate 110 together with the circumference 160 may be molded at the same time.

To mold the cover plate 110 by using the IML injection manner, the cover plate 110 may have to be simplified in structure. It may be necessary to provide a cover frame 120 having a separate coupling structure for coupling the top cover assembly 100 to the front and rear cases 200 and 300.

The top cover assembly 100 may be coupled to the front and rear cases 200 and 300 due to the coupling structure between the cover frame 120 and the cover plate 110. The cover plate 110 may have a simplified structure due to the cover frame 120 coupled to the front and rear cases 200 and 300, and thus the cover plate 110 may be injection-molded by using the ILM manner.

The cover frame 120 may be mounted on a bottom surface of the cover plate 110 and may have a ring shape with a size corresponding to that of the cover plate 110. Frame coupling parts 121, disposed on the bottom surface of the cover plate 110 and spaced a predetermined distance from each other along a circumference of the cover plate 110, may be provided on the cover frame 120.

A screw S, which is disposed at a position corresponding to each of the cover coupling parts 115, may be coupled to the cover plate 110. The cover coupling part 115 may extend downward. The extending cover coupling part 115 may be inserted into the frame coupling part 121.

When the screw S is coupled upward from a lower side, the screw S may pass through the frame coupling part 121 and may then be coupled to the cover coupling part 115. The cover frame 120 may be fixed to the cover plate 110.

A frame fixing part 122, extending downward and through which the screw S coupled to the housing assembly 500 passes, may be disposed on each of both left and right sides of the cover frame 120. The frame fixing part 122 may be configured to be maintained when the top cover assembly 100 is fixed to the housing assembly 500.

A plurality of frame fixing hooks 123 may be disposed along a circumference of the bottom surface of the cover frame 120. The top cover assembly 100 may be hooked with top cover coupling parts 311 disposed on the front case 200 and the rear case 300 through the frame fixing hooks 123.

The cover frame 120 may be coupled to the front case 200 and the rear case 300. Since the cover frame 120 is coupled to the cover plate 110, the top cover assembly 100 and the front and rear cases 200 and 300 may have structures through which the top cover assembly 100 and the front and rear cases 200 and 300 are coupled and fixed to each other.

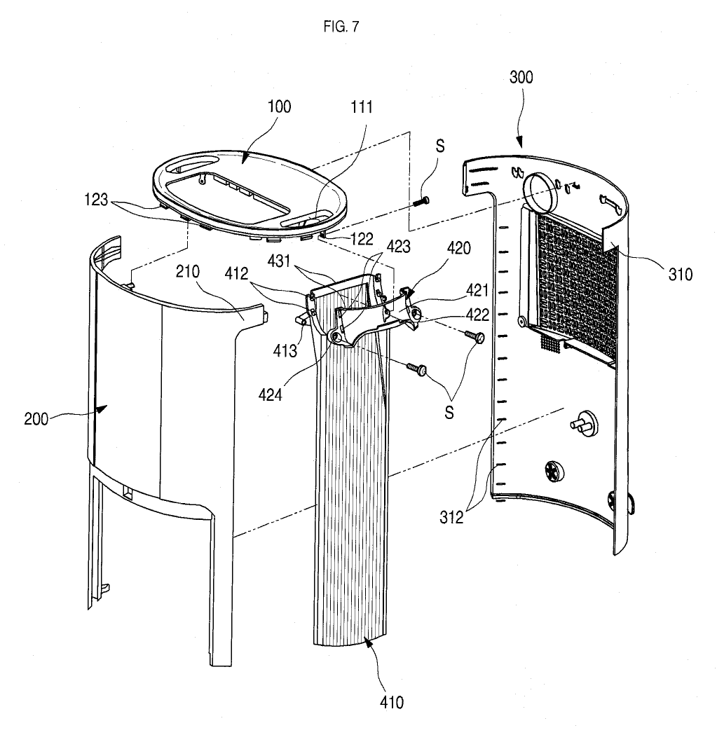

FIG. 7 is an exploded perspective view illustrating a coupling structure of the side deco. Other embodiments and configurations may be provided.

The side deco 400 may define a portion of a side surface of the dehumidifier 1. The side deco 400 may be disposed between the top cover assembly 100 and the base pan 11 so that upper and lower ends of the side deco 400 are respectively fixed to the top cover assembly 100 and the base pan 11. The side deco 400 may be disposed between the front case 200 and the rear case 300 so that a front end of the side deco 400 is coupled to the front case 200, and a rear end of the side deco 400 is coupled to the rear case 300.

The side deco 400 may have a vertically long plate shape, and may include a deco member 410 and a handle member 420. The deco member 410 may define a side shape of the dehumidifier 1. The deco member 410 has an upper end contacting a bottom surface of the cover plate 110 and a lower end contacting the base pan 11.

The handle member 420 may be coupled to an upper portion of the deco member 410. An upper end of the handle member 420 may be coupled to the cover plate 110, and may be disposed on an inner side surface of the front extension part 210 and the rear extension part 310 to form the handle 40.

The deco member 410 may have a rectangular plate shape. A plurality of deco coupling holes may be vertically defined at a predetermined distance in both left and right ends of the deco member 410. Each of the deco coupling holes may have a shape corresponding to that in which each of the deco coupling parts 312 of the front and rear cases 200 and 300 is insertable when the side deco 400 is mounted. The deco member 410 may be maintained in the state where the deco member 410 is coupled to the front and rear cases 200 and 300. A lower end of the deco member 410 may be inserted into and fixed to the base pan 11, and an upper end of the deco member 410 may be fixed to match the cover plate 110.

An upper portion of the deco member 410 may be rounded inward, and the handle member 420 may be disposed on the upper end of the deco member 410. Both side ends of the deco member 410 and the handle member 420 may be coupled to each other to define an opening 430 in a space therebetween. Both side ends of the deco member 410 and the handle member 420 may be spaced apart from each other by a distance corresponding to the handle hole 111 to form a portion of the handle 40.

To couple the deco member 410 to the handle member 420, a handle coupling protrusion 412, protruding in a direction of the handle member 420, may be disposed on each of both sides of the deco member 410. An end of the handle coupling protrusion 412 may be bent and hooked with the handle member 420.

A deco fixing part 413, extending in a lateral direction, may be disposed on each of both sides of the deco member 410. The deco fixing part 413 may be coupled to the handle coupling part 424. The deco fixing part 413 and the handle coupling part 424 may be fixed by the screw S that is coupled to pass through the handle coupling part 424 and the deco fixing part 413.

Both ends of the handle member 420 may be coupled to the deco member 410. Each of both ends of the handle member 420 may be rounded to have a curvature corresponding to that of the handle hole 111. Both ends of the handle member 420 may form a space therebetween, into which the user's hand is inserted when the handle member 420 is coupled to the deco member 410.

A round part 421, having a curvature in a vertical direction, may be disposed on the handle member 420. The round part 421 may protrude outward toward a lower side thereof so that the user is inserted to grasp an inner surface of the handle member 420. A handle support 422, extending upward to contact the inner surfaces of the front extension part 210 and the rear extension part 310, may be further disposed on a lower end of the handle member 420. Even though the user grasps the handle 40, the handle 40 may be stably maintained without being damaged.

A handle coupling hole 423, into which the handle coupling protrusion 412 is inserted, may be defined in each of both left and right ends of the handle member 420. The handle coupling hole 423 may be lengthily defined in a vertical direction so that the handle coupling protrusion 412 moves downward after being inserted into the handle coupling hole 423 to restrict the handle member 420 by the handle coupling protrusion 412.

The handle coupling part 424, extending bilaterally, may be disposed on each of both left and right ends of the handle member 420. The handle coupling part 424 may be disposed at a position corresponding to the deco coupling part 413, and the screw S may pass through the handle coupling part 424. The handle support 422 surrounding and supporting the deco coupling part 413 may protrude from the handle coupling part 424. When the handle member 420 and the deco member are coupled to each other, the handle support 422 may be disposed to be closely attached to the deco coupling part 413. Thus, a screw S may be coupled to an exact location.

The handle member 420 may have a vertical width corresponding to the front extension part 210 and the rear extension part 310. The lower end of the handle member 420 may have a round part with a curvature corresponding to that of a lower end of each of the front extension part 210 and the rear extension part 310. Thus, when the front case 200 and the rear case 300 are coupled to each other, the handle 40 may be stably formed without being exposed to the outside.

The handle member 420 and the deco member 410 may be coupled to each other to allow the upper end of the side deco 400 to form the opening 430. The opening 430 has a shape corresponding to that of the handle hole 111. The opened circumference of the handle hole 111 may extend to be rounded downward. The rib stepped part 119 may be disposed on a lower end of the handle hole 111. The deco stepped part 431 may be disposed on the upper end of each of the deco member 410, and the handle member 420, which corresponds to the rib stepped part 119, may be disposed so that the deco stepped part 431 and the rib stepped part 119 match each other.

The coupling structure between the front case 200 and the rear case 300 and between the side deco 400 and the cover plate 110 may provide the stable handle structure as well as the fixing of the side deco 400.

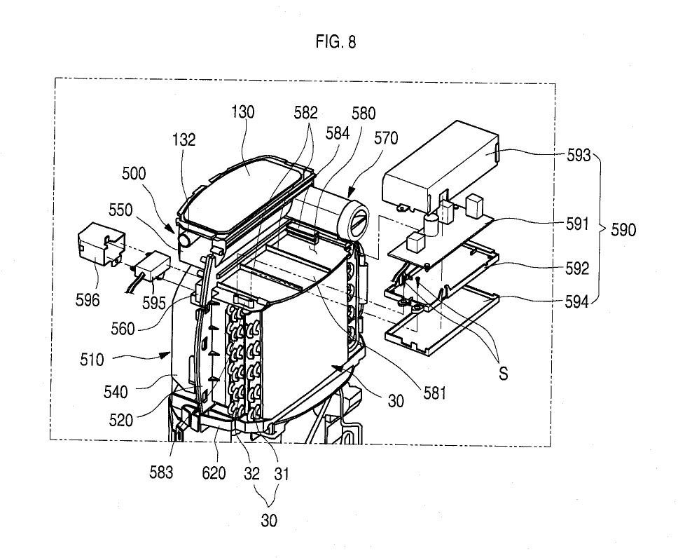

FIG. 8 is an exploded perspective view illustrating a coupling structure of a PCB assembly. Other embodiments and configurations may also be provided.

Referring to FIG. 8, when the control box mounting part 580 is disposed on the housing assembly 500, the control box 590 is mounted on the control box mounting part 580. The control box mounting part 580 may be disposed at a rear side of the louver 130 mounted on the housing assembly 500 to form a seating surface 581 that extends backward.

A pair of ribs 582 protruding upward may be disposed on the seating surface 581. Each of the ribs 582 lengthily extend in a front/rear direction to support a lower portion of the control box 590.

A box fixing part 583 may protrude from one side of the seating surface 581. The box fixing part 583 may be disposed at a position corresponding to a box coupling part that extends laterally from one side of the control box 590. The screw S may pass through the box coupling part and then be coupled to fix the control box 590.

A box guide 584 may be disposed on one side facing the box fixing part 583. The box guide 584 may be lengthily disposed in a front/rear direction so that a guide piece of the control box 590 is slidably inserted.

When the control box 590 is mounted, the guide piece of the control box 590 may move backward, and may be inserted into the box guide 584. When the control box 590 completely moves, the box coupling part may be disposed at a position that overlaps the box fixing part 583. In this state, the screw S may be coupled from an upper side to fixedly mount the control box 590 on the control box mounting part 580.

On the other hand, if service for the control box 590 is required, the coupling of the screw S may be released, and then the control box 590 may slide backward to easily separate the control box 590.

The control box 590 may include the PCB 591 on which various devices for controlling operation of the dehumidifier 1 are mounted, a board base 592 formed of a plastic material to accommodate the PCB 591, and a board case surrounding upper and lower portions of the board base 592.

The board base 592 may define a space in which the PCB 591 is accommodated. The box coupling part and the guide piece may protrude outward from both ends of the board base 592, respectively.

The board case 154 may include an upper case 593 and a lower case 594. The board base 592, in which the PCB 591 is accommodated, may be mounted in a space between the upper case 593 and the lower case 594. The board case 154 is formed of a metal material such as stainless steel. Even if a fire occurs in the PCB 591, the combustion may occur only within the board case 154 to prevent the fire from being spread to other components of the dehumidifier 1.

The capacitor mounting part 560 may be further disposed at a front side of the control mounting part 580. The capacitor mounting part 560 may be disposed adjacent to the control box mounting part 580. The capacitor 595 may be accommodated into the capacitor cover 596 having an accommodation space therein. The capacitor cover 596 may be coupled to the capacitor mounting part 560.

The capacitor 595 may be fixed to the capacitor mounting part 560. The capacitor cover 596, formed of a metal material such as stainless steel, may completely surround the capacitor 595 to protect the capacitor 595 against fire, for example.

The capacitor 595 may have a relatively high height. Thus, if the capacitor 595 increases in capacitance, the capacitor 595 may further increase in size. Thus, since the capacitor 595 and the capacitor cover 596 are separated from the control box 590, the mounting space of the control box 590 may be more utilized, and also the inner space of the dehumidifier 1 may be efficiently used.

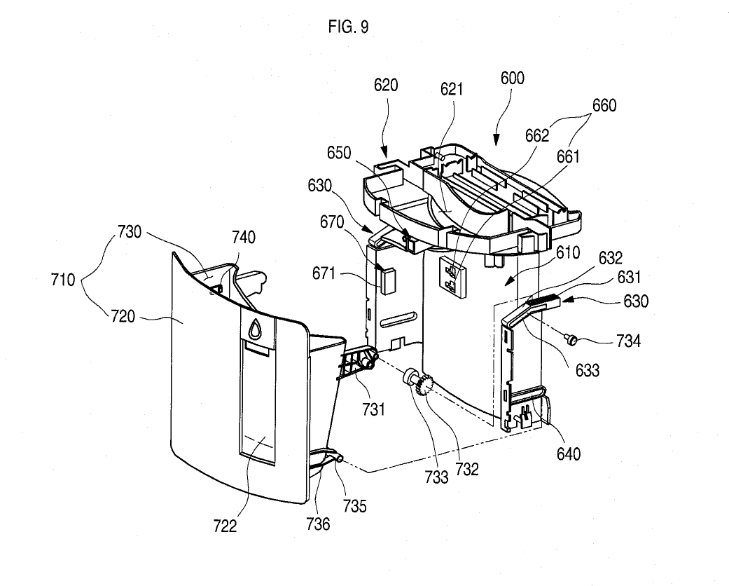

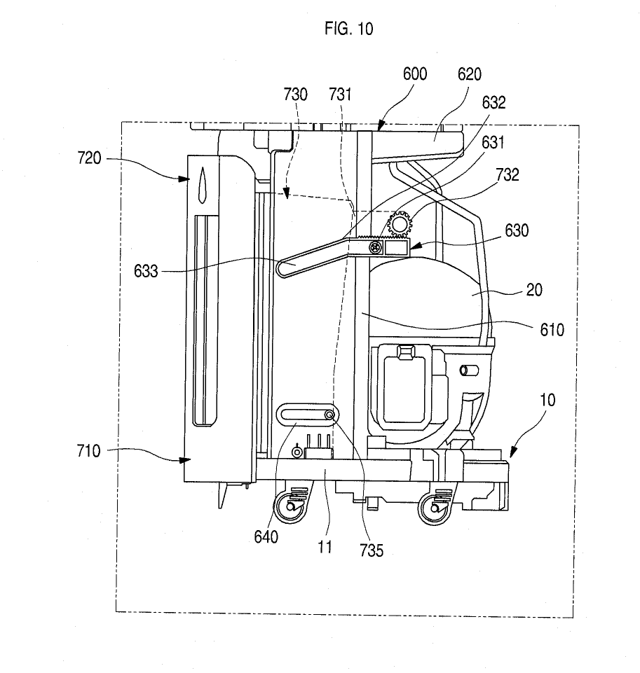

FIG. 9 is an exploded perspective illustrating a coupling structure of a tank drawer. FIG. 10 is a side view illustrating a structure of a guide assembly for guiding insertion/withdrawal of the water tank assembly. Other embodiments and configurations may also be provided.

Referring to FIGS. 9 and 10, the water tank assembly 700 is disposed at a front side of the vertical part 610 of the frame 600. A space in which a tank drawer 710 (constituting the water tank assembly 700) is accommodated is at the front side of the vertical part 610. When the water tank 800 is completely inserted, the tank drawer 710 may disposed on the same plane as a front surface of the cover plate 110.

A latch 650, into which the locker 721 is inserted to selectively restrict the locker 721, is provided at a central portion of the front surface of the frame 600, and more particularly at a front end of the horizontal part 620. The latch 650 may be provided at a position corresponding to the latch hole 222. When the tank drawer 710 is closed, the latch 650 may be hooked with the locker 721 to maintain the closed state of the tank drawer 710.

When the latch 650 is inserted once, the latch 650 may be hooked with the locker 721. When the locker 721 moves again forward by an external force, the hooking between the latch 650 and the locker 721 may be released to allow the tank drawer 710 to be withdrawn. That is, the hooking structure between the latch 650 and the locker 721 may be similar to a latching structure, such as a general pushing manner.

The locking unit (including the latch 650 and the locker 721) may have a locking structure different from structures of the latch 650 and the locker 721. Various structures for maintaining the closed state of the tank drawer 710 may be selectively applied.

A full level detection part 660 may be provided on the front surface of the vertical part 610 toward the tank drawer 710. A pair of sensors may be vertically disposed on the full level detection part 660 to determine a full level of water by detecting a position of a floater of the water tank 800.

When a position of the floater 830 is detected by the sensor for detecting the full level of the water tank 800, the lower water level sensor 661 (of the pair of sensors) transmits a full level signal to the display part 152 to inform the full level of the water tank 800.

When a position of the floater is detected by an upper safety sensor 662 (of the pair of sensors), operation of the dehumidifier 1 may stop to prevent the condensed water from being further collected in the water tank 800. The full level may be informed to the outside to allow the user to empty the water tank 800.

A lighting module 670 may be mounted on one side of the vertical part 610 corresponding to a lateral side of the tank drawer 710. The lighting module 670 may irradiate light into the water tank 800 to visualize a water level of the water tank 800 and function as an indirect lighting. Thus, the light may irradiate from one side toward the inside of the water tank 800.

A lighting hole 671 may be at a side surface of the tank drawer 710 or a position corresponding to the lighting module 670 to emit light into the water tank 800 when the water tank 800 is accommodated in the tank drawer 710.

The main guide 630 and the sub guide 640 are disposed on both left and right sides (first and second sides) of the vertical part 610, respectively. The main guide 630 and the sub guide 640 may guide the slidable insertion/withdrawal and tilting of the tank drawer 710. The main guide 630 and the sub guide 640 may be disposed on both left and right sides of the vertical part 610. The sub guide 640 may be disposed below the main guide 630.

The main guide 630 may be disposed on each of both sides (first and second sides) of the vertical part 610, and may also be disposed above the sub guide 640. The main guide 630 may include a horizontal part and a rotation part 633. The main guide 630 may guide horizontal movement of the tank drawer 710, and may guide rotation of the tank drawer 710.

A top surface of the horizontal part 631 may have a rack gear (or rack gear shape), and may be engaged with a pinion gear 732. The horizontal part 631 may extend in a front/rear direction to guide horizontal movement of the tank drawer 710.

The rotation part 633 may extend to be tilted or rounded from a front end of the horizontal part 631 at a predetermined angle. A rotation guide hole 633 may be in a center of the rotation part 633. The rotation guide hole 633 may extend along a portion of a front portion of the horizontal part 631 and the rotation part 633. A guide member 734 may be inserted into the rotation guide hole 633.

When the tank drawer 710 moves forward, the pinion gear 732 may move such that the pinion gear 732 is gear-coupled to the rack gear disposed on a top surface of the horizontal part 631. The guide member 734 may move along the rotation guide hole 633. After the tank drawer 710 is withdrawn forward (or moved forward), the tank drawer 710 may rotate based on the center of gravity. The guide member 734 may guide the rotation of the tank drawer 710 while moving along the rotation guide hole 633.

The sub guide 640 may be disposed on each of both sides (first and second sides) of the vertical part 610, and the sub guide 640 may also be disposed below the main guide 630. The sub guide 640 may guide movement of a lower portion of the tank drawer 710 when the tank drawer 710 moves. The sub guide 640 may guide the tank drawer 710 so that the tank drawer 710 is more stably withdrawn (or moved forward). The sub guide 640 may extend in a front/rear direction, and a rotation protrusion 735 may be inserted into the sub guide 640. Thus, the sub guide 640 may guide the forward/backward movement of the rotation protrusion 735.

The water tank assembly 700 may collect condensed water generated at the heat exchange module 30. The water tank assembly 700 may be disposed in a space at a front side of the frame 600. The water tank assembly 700 may be connected to the frame 600 and may slide to be inserted or withdrawn in a front/rear direction. When the water tank assembly 700 is completely withdrawn (or moved forward), the water tank assembly 700 may rotate by using a lower portion thereof as a shaft, and may then be tilted to open a top surface thereof.

The water tank assembly 700 may include the water tank 800 for storing the condensed water and the tank drawer 710 in which the water tank 800 is accommodated and inserted/withdrawn so that the water tank 800 is easily mounted or separated.

The tank drawer 710 may define an outer appearance of a front surface of the water tank assembly 700. The tank drawer 710 may include a front surface part 720 defining a portion of the front surface of the dehumidifier 1 (i.e., a portion of the front case 200 and an accommodation part 730 opened upward from a rear side of the front surface part to accommodate the water tank downward from an upper side).

The accommodation part 730 may have a shape corresponding to that of the water tank 800. The accommodation part 730 may be opened upward so that water is easily supplied, and the water tank 800 is easily inserted or withdrawn when the water tank 800 is mounted.

The locker 721 (extending backward) may be disposed on a central portion of an upper end of the front surface part 720. The locker 721 may extend backward and may be coupled and fixed to the latch 650 when the water tank assembly 700 is completely inserted.

An identification hole 722 may be at one side of the first surface part 720. The identification hole 720 may identify a water level of the water tank 800 (mounted at the accommodation part 730) through a naked eye. The identification hole 722 is lengthily disposed in a vertical direction. The identification hole 722 may be disposed so that at least a portion of the water tank 800 is exposed.

Thus, when the light is irradiated into the water tank 800 by the lighting module 670, the light irradiated into the water tank 800 may be identified through the identification hole 722 from the outside.

A detection hole 731 for detecting a water level is opened in a rear surface of the accommodation part 740. The detection hole 740 is opened in a shape corresponding to that of the full level detection part 660. Thus, the full level or dangerous level within the water tank 800 may be easily detected through the detection hole 731.

An upper extension part 732 and a lower extension part 731, which extend backward, may be provided in a pair on both sides of the accommodation part 736. The upper extension part 731 may extend upward from the accommodation part 730, and the lower extension part 736 may extend backward from the lowest portion of the accommodation part 730.

The upper extension part 731 may further extend backward from the lower extension part 736, and the guide member 734 and the pinion gear 732 may be disposed on the upper extension part 731.

The guide member 734 may protrude from a corresponding position so that the guide member 734 moves along the rotation guide hole 633 (of the main guide 630). To smoothly move the tank drawer 710, a roller may be coupled to an end of the guide member 734. The roller may roll along the rotation guide hole 633.

The pinion gear 732 may be disposed on a rear end of the upper extension part 731. The pinion gear 732 may be gear-coupled to the rack gear of the horizontal part 631. The pinion gear 732 may rotate when the tank drawer 710 moves in the front/rear direction. The tank drawer 710 may not move in a horizontal direction, but may be stably inserted or withdrawn by the pinion gear 732.

To rotate the pinion gear 732, a driving motor 733 may be further provided on the upper extension part 731. The driving motor 733 may be connected to a rotation shaft of the pinion gear 732. Thus, the pinion gear 732 may forwardly or reversely rotate by driving manipulation of the driving motor 733, and thus the tank drawer 710 may be inserted or withdrawn in the front/rear direction. The driving motor 733 may be manipulated in operation by the manipulation part 151.

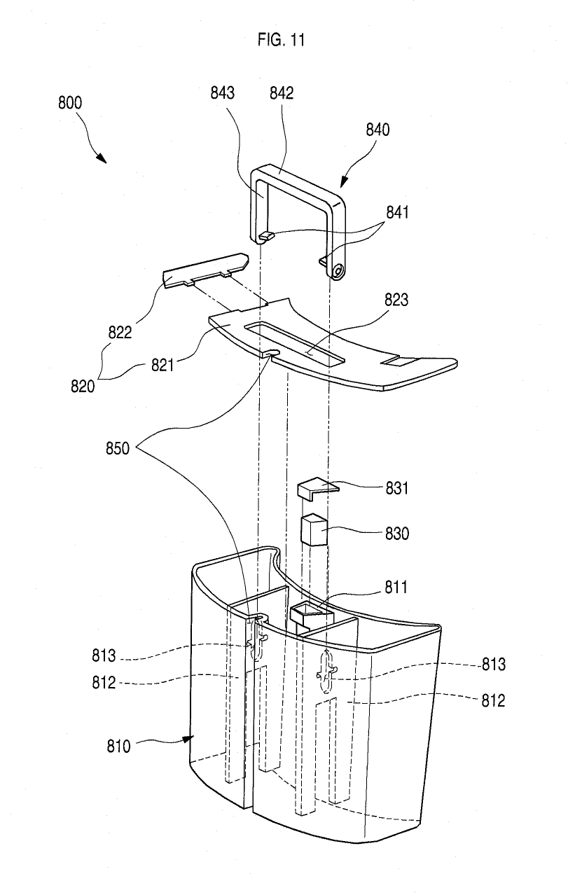

FIG. 11 is a perspective view of a water tank.

Referring to FIG. 11, the water tank 800 may have a shape corresponding to an inner shape of the accommodation part 730. The water tank 800 may include a lower transparent water collection part 810 and an upper water collection part cover 820.

The water collection part 810 may be formed of a transparent acrylic or plastic material so that the inside of the water tank 800 is seen from the outside, and the water collection part 810 is easily molded. A floater accommodation part 811, for accommodating the floater 830, is disposed inside the water collection part 810. The floater accommodation part 811 may be opened upward and define an independent space. The floater accommodation part 811 may be lengthily disposed in a vertical direction to secure a moving path of the floater 830 and maintain the same water level as the inside of the water tank 800. The floater 830 is accommodated into the floater accommodation part 811. The floater 830 may vertically move according to a water level.

The floater accommodation part 811 may be disposed at a position corresponding to the full level detection part 660. Thus, a position of the floater 830, which includes a magnet therein and moves along the floater accommodation part 811, may be detected by a sensor of the full level detection part 660. The opened top surface of the floater accommodation part 811 may be covered by the floater cover 831 to prevent the floater 830 from being lost and locate the floater 830 within the floater accommodation part 811.

A pair of handle mounting parts 812 may be disposed within the water tank 800. A tank handle 840, to be grasped by the user to move the water tank 800, may be disposed on the handle mounting part 812. A mounting hole 813, lengthily defined in a vertical direction, may be defined in the handle mounting part 812.

A mounting protrusion 841 (of the tank handle 840) has a structure that is inserted into the mounting hole 813. The tank handle 840 may vertically move along the mounting hole 813. Thus, when the user separates or moves the water tank 800, the tank handle 840 may be withdrawn upward. When the water tank 800 is mounted on the water drawer 710, the tank handle 840 may move downward to insert the water handle 840 into the water collection cover 820.

The water collection cover 820 may cover the opened top surface of the water collection part 810. The water collection cover 820 may include a cover part 821 covering the top surface of the water collection part 810 and an opening part 822 rotatably disposed on one side of the cover part 821 to open a portion of the top surface of the water collection part 810.

When the water filled into the water collection part 810 is discarded, the opening part 822 may rotate to discard the water within the water collection part 810, or the water collection cover may be separated to discard the water.

A handle hole 823 is defined in the water collection cover 820. The handle hole 823 may have a size corresponding to a horizontal size of the tank handle 840 to define a passage through which the tank handle 840 is inserted or withdrawn.

The tank handle 840 may include a grasping part 842 to be grasped by the user and an extension part 843 extending downward from each of both ends of the grasping part 842. A mounting protrusion 841 (protruding inward) may be disposed on a lower end of the extension part 843. The mounting protrusion 841 may vertically move along the mounting hole 813 defined in the water collection part 810.

When the tank handle 840 is not used, the tank handle 840 may move downward. When the tank handle 840 is completely inserted, the tank handle 840 may be inserted so that a top surface of the tank handle 840 is disposed on the same plane as a top surface of the water collection cover 820.

A locker groove 850, recessed backward, may be lengthily defined in a vertical direction in each of centers of the water collection part 810 and the water collection part cover 820. When the water tank 800 is mounted, the locker 721 may be inserted into the locker groove 850. That is, the locker 721 may be inserted into the locker groove 850 when the water tank is mounted on the accommodation part 730 to prevent the water tank 800 from moving. When the water tank 800 is inserted or withdrawn, the locker 721 may move along the locker groove 850.

Operation of the dehumidifier having the above-described structure may be described.

In order to operate the dehumidifier 1, the user may locate the dehumidifier 1 in a space to be dehumidified. Since the dehumidifier 1 includes the wheel 12 on the bottom surface thereof and the handle 40 on both sides of the top surface thereof, the dehumidifier 1 may easily move even though the dehumidifier 1 has a large size.

The user may insert a hand thereof into the handle hole 111 (defined in the top surface of the cover plate 110) to grasp the handle 40 through the space defined in a side of the side deco 400, thereby stably moving the dehumidifier 1.

When the dehumidifier 1 is placed at a specific position, the user may manipulate the dehumidifier 1 to drive the dehumidifier 1. As the dehumidifier 1 is manipulated, the compressor 20 and the motor 530 operate, and the louver 130 rotates to expose the discharge hole 131 to the outside.

As the compressor 20 operates, the refrigerant flows through a refrigerant cycle. The compressor 20 may discharge a high-temperature high-pressure liquid refrigerant. The evaporator 31 may be cooled by low-temperature cool air introduced into the evaporator 31 via the expansion unit. The refrigerant that is heat-exchanged with the external air in the evaporator 31 to change in phase may flow toward the condenser 32. The refrigerant may be heat-exchanged again in the condenser 32 to return to the compressor 210. The evaporator may be continuously cooled, and the condenser 32 may be heated due to the above-described refrigerant cycle.

The blowing fan 540 may rotate based on operation of the motor 530. Thus, since the blowing fan 540 rotates, air of an indoor space, in which the dehumidifier 1 is disposed, may be forcibly suctioned into the dehumidifier 1 through the suction hole 331.

The suctioned air may pass through the evaporator 31. While the air passes through the evaporator 31, moisture contained in the air may be condensed while being heat-exchanged with the evaporator 31 to flow along the evaporator 31. The air passing through the evaporator 31 may pass through the condenser 32. The air heated by the condenser 32 may change into dried air and may then be introduced into the orifice 521.

The air introduced into the orifice 521 may flow along the inner wall of the housing case 510 by the blowing fan 540, and may be discharged again into the indoor space through the louver 130.

This process may be repeatedly performed until humidity of the indoor space reaches a preset humidity or according to the user's set. Generated condensed water of the evaporator 31 may be introduced into the water tank 800 through the drain passage 621 defined in the horizontal part 620 of the frame 600. The condensed water introduced into the water tank 800 may be collected in the water collection part 810. The condensed water may be continuously collected until reaching a preset water level.

When an amount of water collected into the water tank 800 increases to reach the preset water level, the floater 830 may move upward. When a position of the floater 830 is detected by the water level sensor 661, the full level state may be informed by using the display part 152 so that the user discards the water within the water tank 800. When a position of the floater 830 is detected by the safety sensor 662, operation of the dehumidifier 1 may stop to prevent water within the water tank 800 from overflowing.

The lighting module 670 may operate by the user's manipulation or set during operation of the dehumidifier 1. When the lighting module 670 operates, the water tank 800 may emit light such as an indirect lighting so that the water level of the water collected into the water tank 800 may be easily identified from the outside.

An example in which the water tank reaches a full level, or water within the water tank has to be discarded may be described in detail with reference to the drawings.

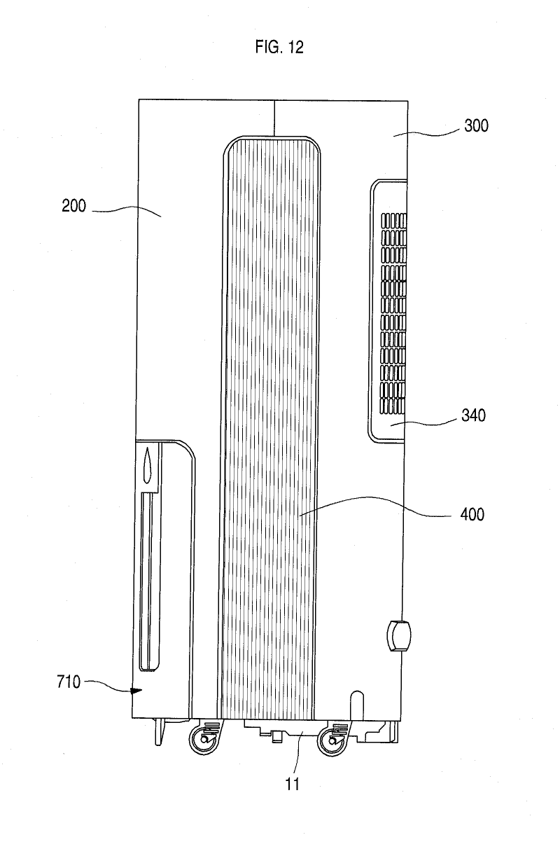

FIG. 12 is a side view of the dehumidifier before the water tank assembly is withdrawn.

Referring to FIG. 12, before the dehumidifier 1 normally operates to reach the full level of the water tank 800, the tank drawer 710 may be maintained in the closed state. If the tank drawer 710 is closed, the front surface of the tank drawer 710 may be disposed on the same plane as the front case 200 to realize a sense of unity.

In this state, the guide member 734 may be disposed at a rear portion of the main guide hole 633 (of the main guide 630). The pinion gear 732 may be maintained in the state in which the pinion gear 732 is engaged with the rack gear at a rear portion of the top surface of the horizontal part 631. The rotation protrusion 735 may be disposed at the rearmost position of the sub guide 640.

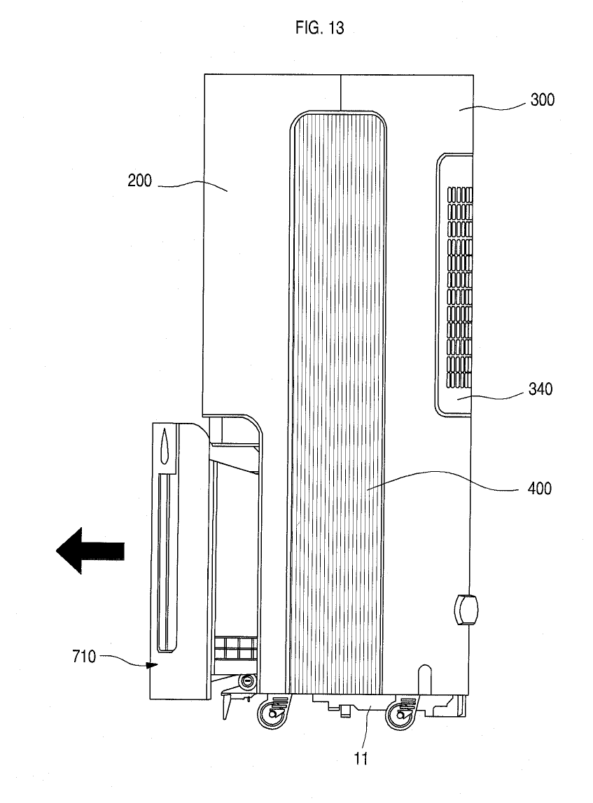

FIG. 13 is a side view of the dehumidifier when the water tank assembly is withdrawn. FIG. 14 is a side view of the guide assembly when the water tank assembly is withdrawn.

As shown in FIGS. 13 and 14, the manipulation part 151 may be manipulated to open the tank drawer 710. The driving motor 733 may rotate by manipulation of the manipulation part 151. The pinion gear 732 may move forward along the horizontal part 631 of the main guide 630 by rotation of the driving motor 733.

As the pinion gear 732 moves, the tank drawer 710 may be opened while horizontally moving forward.

The guide member 734 may move along the sub guide 640. When the tank drawer 710 completely moves to the front side, the guide member 734 may be disposed at a front end of the sub guide 640.

The forward movement of the tank drawer 710 may be performed by releasing the restriction of the latch 721 and the locker 650 without using a separate driving motor. A tilted part 737, formed on the bottom surface of the tank drawer 710, may contact the base roller 15. Thus, the base roller 15 may roll along the tilted part 737 by weight of the water tank 800, and the water tank 710 may move forward by the self-weight thereof.

When the tank drawer 710 completely moves to the front side, the tank drawer 710 may be in a state where the center of gravity of the tank drawer 710 moves forward based on weight of the water tank 800. When the tank drawer 710 moves forward, a portion of the top surface of the water tank 800 may be exposed to the outside.

As described above, the tank drawer 710 may be slidably withdrawn forward (or moved forward) till the state of FIGS. 13 and 14.

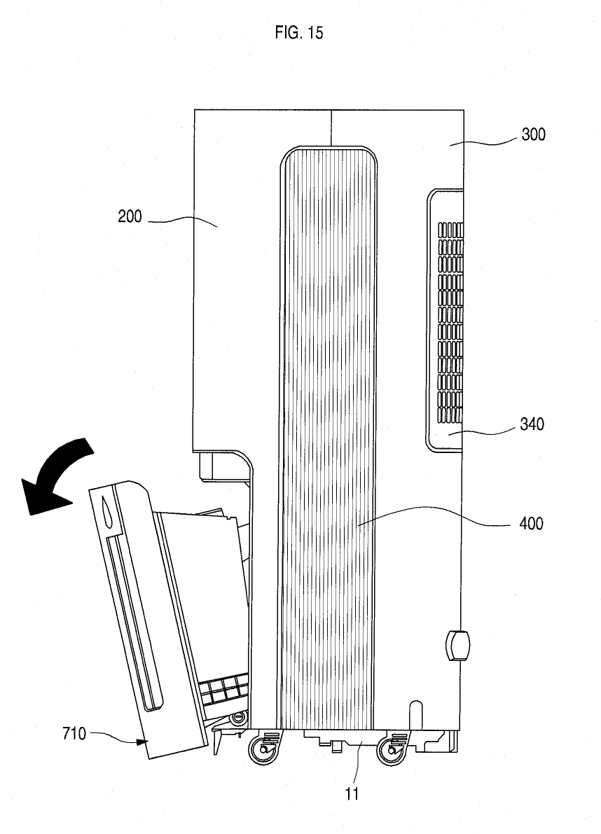

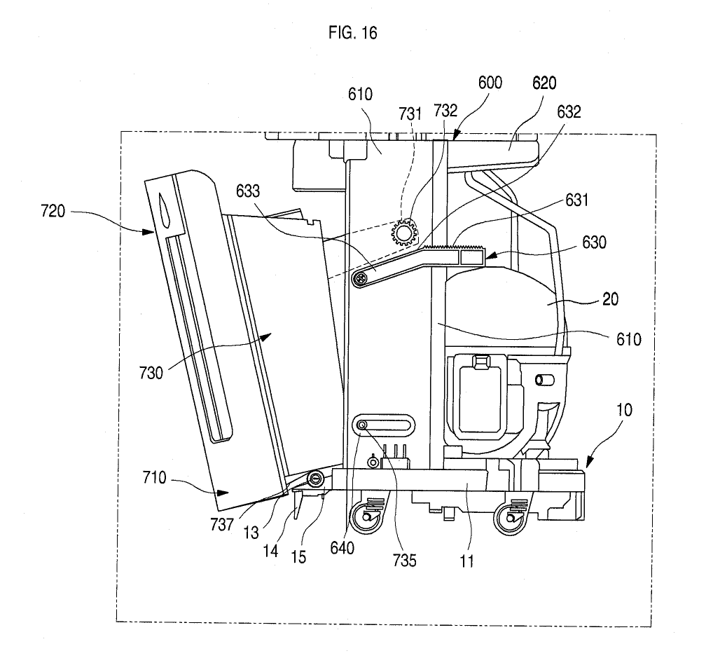

FIG. 15 is a side view of the dehumidifier when the water tank assembly is tilted after being withdrawn. FIG. 16 is a side view of the guide assembly when the water tank assembly is tilted after being withdrawn.

As shown in FIGS. 15 and 16, when the tank drawer 710 is completely withdrawn, the center of gravity of the tank drawer 710 may be disposed at a front side based on the weight of the water tank 800. In this state, the tank drawer 710 may rotate with respect to the rotation protrusion 735.

The tank drawer 710 may rotate, and the guide member 734 may move along the main guide hole 633. That is, the tank drawer 710 may rotate by using the rotation protrusion 735 as an axis. As the tank drawer 710 rotates, the top surface of the water tank 800 may be exposed upward.

If the tank drawer 710 is completely tilted by the rotation thereof, the tank drawer 710 may come to the state shown in FIGS. 15 and 16. Each of the guide member 734 and the rotation protrusion 735 may be disposed at the foremost position of the main guide hole 633 and the sub guide 640, respectively.

Even though the tank drawer 710 is completely slid and withdrawn and is tilted, the main body of the dehumidifier 1 may not fall forward by a main body support 14 that extends downward from a front end of the base plate 11. Thus, the tank drawer 710 may be stably inserted and withdrawn, and the water tank 800 may be stably detached.

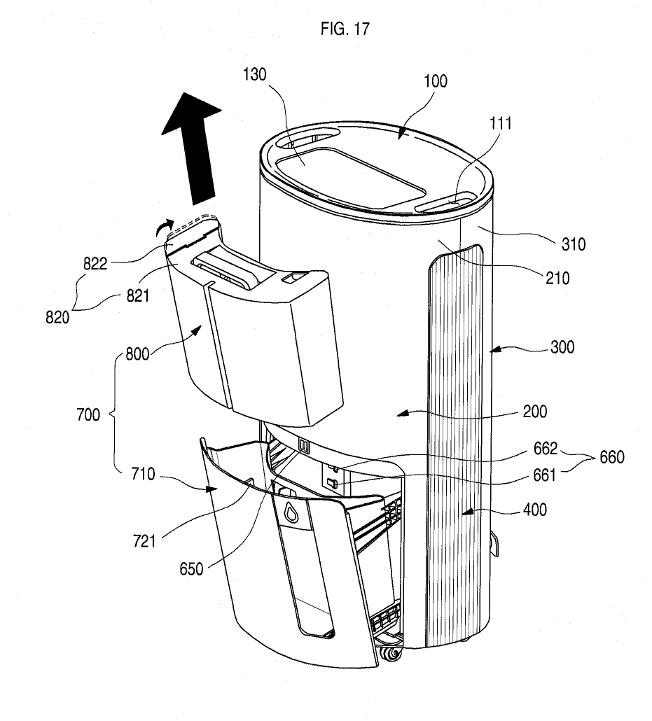

FIG. 17 is a perspective view illustrating a state when the water tank is separated from the water tank assembly.

Referring to FIG. 17, when the tank drawer 710 is completely tilted, the water tank 800 may be withdrawn from the accommodation part 730. The water tank 800 may be separated from the accommodation part 730, and the opening part 822 of the water tank 800 may rotate to discard the water within the water tank 800.

To easily separate and move the water tank 800, the tank handle 840 may be withdrawn upward. Thus, the user may separate or move the water tank 800 while grasping the tank handle 840.

According to another embodiment, a tank drawer may be slidably inserted and withdrawn by a guide rail and have a structure that is tiltable by a drawer frame.

The current embodiment may be equal to the foregoing embodiment except for the guide rail and the drawer frame, and thus same parts may be designated by the same reference numerals, and detailed descriptions thereof may be omitted.

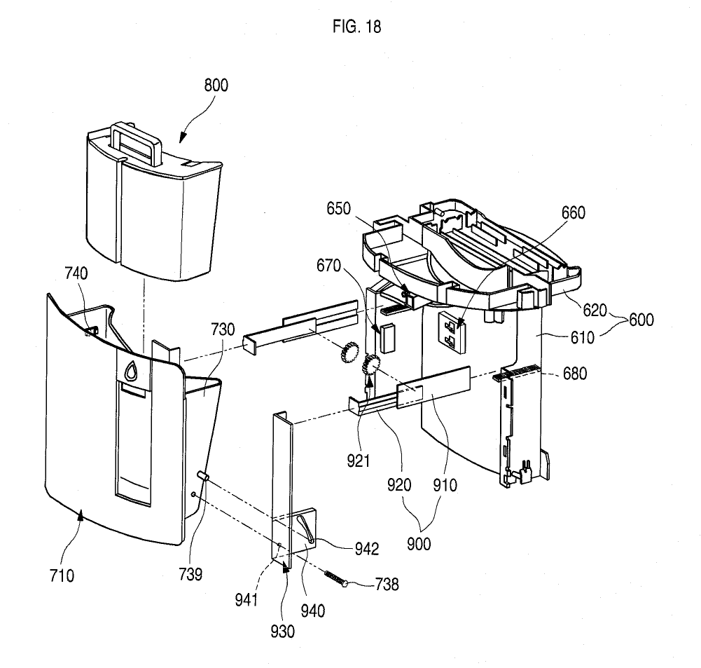

FIG. 18 is an exploded perspective showing a coupling structure of a tank drawer according to an embodiment. Other embodiments and configurations may also be provided.

Referring to FIG. 18, the inside of a dehumidifier 1 may be divided into a front space in which the water tank 800 is accommodated and a rear space in which the compressor 20 is accommodated by the vertical part 610 of the frame 600. The inside of the dehumidifier 1 may be divided into an upper space in which a housing assembly 500 for accommodating a heat exchange module 30 and a blowing fan 540 is provided and a lower space in which the water tank 800 is accommodated by a horizontal part 620 (of the frame 600).

The water tank 800 may be accommodated into the tank drawer 710 that is opened upward. When the tank drawer 710 is inserted or withdrawn, the water tank 800 may be inserted or withdrawn together with the tank drawer 710. The water tank 800 may be detached through an opened top surface of the tank drawer 710.

A full level detection part 660 may be disposed on a front surface of the vertical part 610 that defines the space in which the water tank 800 and the tank drawer 710 are accommodated, and a lighting module 670 may be disposed on a side surface of the vertical part 610 to illuminate the inside of the water tank 800.

A guide rail 900 may be disposed on each of both inner sides (first and second sides) of the frame 600. The guide rail 900 may have a first end that is fixed to each of both side surfaces of the vertical part 610 of the frame 600 and a second end that is fixed to the drawer frame 930 on which the tank drawer 710 is mounted. The guide rail 900 may be slidably inserted and withdrawn in multi stages (or a plurality of stages). The tank drawer 710 may slidably move in a front/rear direction by the guide rail 900, and the tank drawer 710 may then be inserted and withdrawn.

The guide rail 900 may include a fixed rail 910 fixed to the frame 600 and a movable rail 920 that moves along the fixed rail 910. The movable rail 920 may have a front end fixed to the tank drawer 710 and a rear end on which a pinion gear 921 is provided.

A guide rack 680 may be provided under the fixed rail 910. The guide rack 680 may lengthily extend in the front/rear direction, and the guide rack 680 may be gear-coupled to the pinion gear 921. The guide rack 680 may protrude from the inner surface of the frame 600. When the guide rail 900 is mounted, the guide rack 680 may be gear-coupled to the pinion gear 921. When the tank drawer 710 slidably moves, the pinion gear 921 may move along the guide rack 680.

The drawer frame 930 may be provided on each of both left and right sides (first and second sides) of the tank drawer 710. The drawer frame 930 may be lengthily disposed in a vertical direction, and the drawer frame 930 may be coupled to the front end of the guide rail 900. A lower portion of each of both left and right surfaces of the tank drawer 710 may be rotatably coupled to the drawer frame 930 to support the tank drawer 710.

A tilting guide 940 may be disposed on a lower portion of the drawer frame 930. The tilting guide 940 may have a plate shape. The tilting guide 940 may have a coupling hole 941 in which a rotation shaft 738 of the tank drawer 710 is inserted and fixed, and a tilting guide hole 942 for guiding the tilting of the tank drawer 710.

The rotation shaft 738 (of the tank drawer 710) may be disposed on both left and right surfaces of the tank drawer 710. The rotation shaft 738 may protrude to pass through the coupling hole 941. When the water tank 800 is mounted, a center of gravity of the tank drawer 710 may be defined at a front side to generate moment on the tank drawer 710 around the rotation shaft 738. When the tank drawer 710 is withdrawn due to inertia by which the tank drawer 710 is withdrawn, the tank drawer 710 may be tilted.

A guide protrusion 739, protruding from both left and right sides of the tank drawer 710 that is away from the rotation shaft 738, may be accommodated into the tilting guide 940. An arc shape formed along a moving trace of the tilting guide 940 when the tank drawer 710 rotates may be formed to guide movement of the tilting guide 940.

A locker 650 for restricting the tank drawer 710 may be further disposed on an upper portion of the frame 600. A latch 721 may be disposed on a back surface of the front surface of the tank drawer 710, which corresponds to the locker 650. The tank drawer 710 may be restricted in the closed state, and may then be maintained in the closed state. The locker 650 and the latch 721 may push the tank drawer 710 to release restriction of the tank drawer 710. The locker 650 and the latch 721 may be pushed to determine the restriction and release of the tank drawer 710.

A process for inserting and withdrawing the water tank of the dehumidifier having the above-described structure may be described.

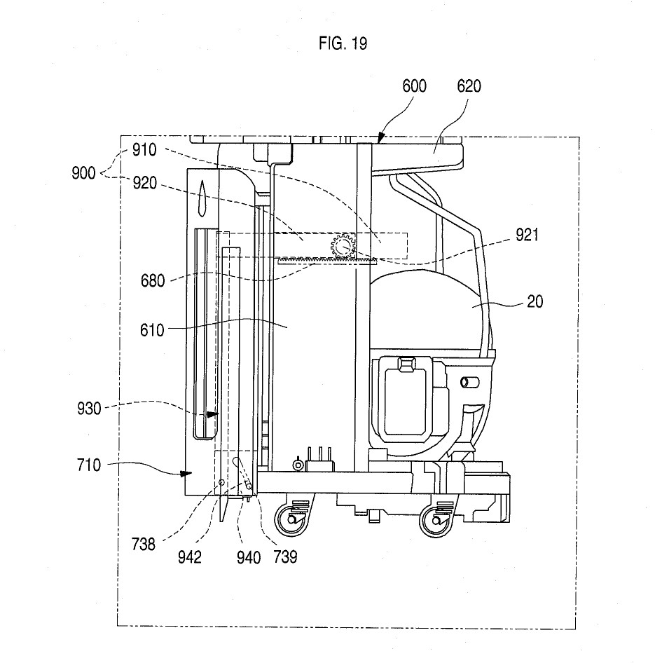

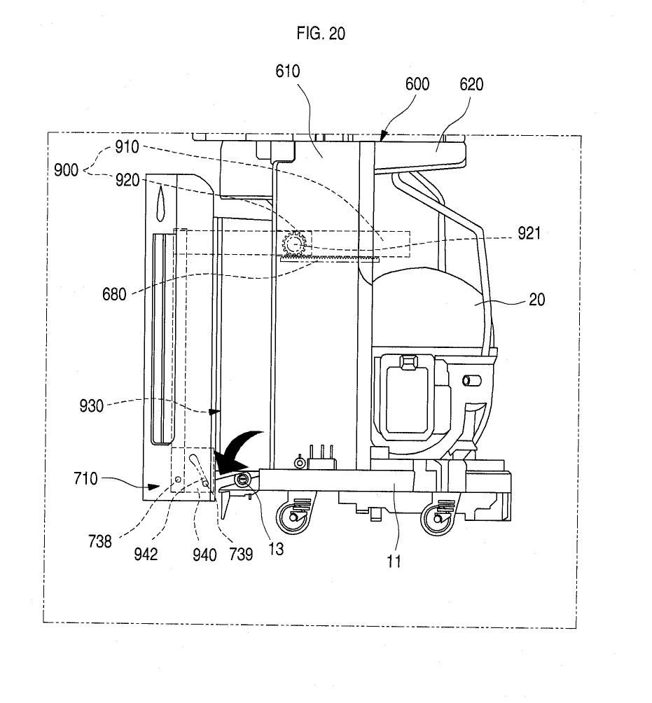

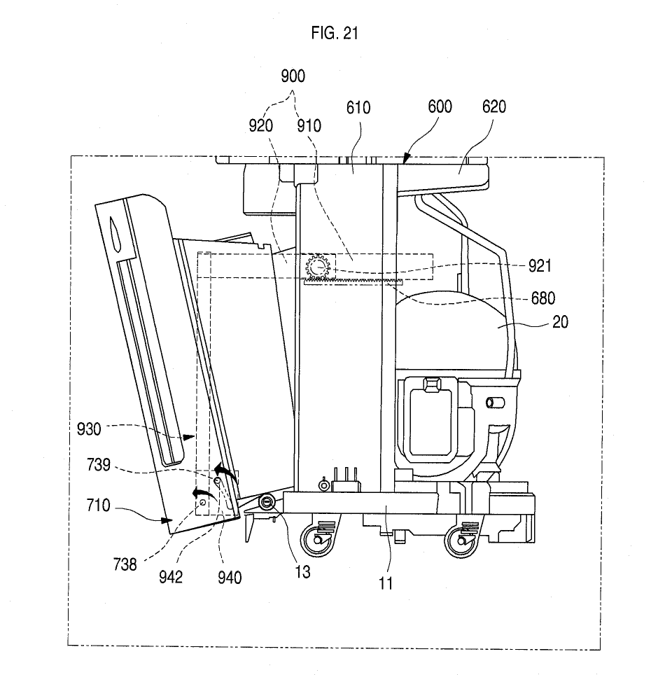

FIG. 19 is a side view of a guide assembly before a water tank assembly according to an embodiment. FIG. 20 is a side view of the guide assembly when the water tank assembly is withdrawn. FIG. 21 is a side view of the guide assembly when the water tank assembly is tilted after being withdrawn. Other embodiments and configurations may also be provided.

Referring to FIGS. 19 to 21, when the dehumidifier 1 is operating, or the water tank does not reach a full level, the tank drawer 710 may be maintained in the closed state as shown in FIG. 19.

When the tank drawer 710 is closed, the guide rail 900 may be completely inserted, and the pinion gear 921 may be disposed at the rearmost position of the guide rack 680. The latch 721 and the locker 650 may be restricted with respect to each other to maintain the closed state of the tank drawer 710. The guide protrusion 739 may be disposed at the lowermost portion of the tilting guide hole 942.

In this state, the locker 650 and the latch 721 may be released in restriction to open the tank drawer 710 so that the water tank 800 reaches the full level to discard water of the water tank 800. The tank drawer 710 may move forward by a repulsive force that is generated when restriction between the locker 650 and the latch 721 is released. Alternatively, like the foregoing embodiment, the tank drawer 710 may move forward based on contact between the tilted part 737 and the roller 15 and the self-weight thereof.

The tank drawer 710 may move forward by a predetermined distance. When the movable rail 920 is fully withdrawn forward, the tank drawer 710 may become to the state shown in FIG. 20. In this state, the pinion gear 921 may move up to a front portion of the guide rack 680, and the top surface of the tank drawer 710 may be opened somewhat.

In this state, the center of gravity of the tank drawer 710 may move forward, and thus the tank drawer 710 may rotate about the rotation shaft 738. The guide protrusion 739 may move along the tilting guide hole 942.

When the tank drawer 710 is completely tilted, the guide member may be disposed at an upper end of the tilting guide hole 942 as shown in FIG. 21. The top surface of the tank drawer 710 may be fully opened to allow the water tank 800 to be easily inserted and withdrawn. In this state, the user may separate the water tank 800 from the tank drawer 710 and then withdraw the water tank 800. The water within the water tank 800 may be discarded, and the water tank 800 may be mounted again.

Even though the tank drawer 710 is completely slid and withdrawn and is tilted, the main body may not fall forward by the main body support 14 that extends downward from a front end of the base plate 11. The tank drawer 710 may be stably inserted and withdrawn, and the water tank 800 may be stably detached.

After the water tank 800 is mounted, the tank drawer 710 may reversely rotate again through processes that are reversely performed with respect to the above-described processes. The tank drawer 710 may be closed to allow the dehumidifier 1 to become to the operable state.

In the dehumidifier according to embodiments, the tank drawer in which the water tank is accommodated may be slid by a predetermined distance and may then be tilted. Thus, the water tank may rotate without being spatially limited to minimize loss of space in which the water tank is accommodated or the space of the main body.

When the tank drawer is withdrawn, the tank drawer may be slidably withdrawn by self-weight of the water tank, and may then be tilted to allow the user to easily withdraw the water tank.

In the example of the dehumidifier having a large capacity, although it is difficult to withdraw and separate the water tank due to the heavy water tank, it may be unnecessary to perform a separate withdrawing operation for slidably withdrawing the water tank due to self-weight of the water tank. Since the upper portion of the water tank is maximally opened, the water tank may be easily withdrawn.

Additionally, when the tank drawer is withdrawn, the tank drawer may be maintained in the stably mounted state, as well as, the main body may not be reversed by movement of the center of gravity. Therefore, the tank drawer may be stably used.

Embodiments may provide a dehumidifier in which a water tank that contains condensed water is easily withdrawn and a method for withdrawing the water tank of the dehumidifier.

In one embodiment, a dehumidifier includes: a main body in which a heat exchange module is disposed; a water tank disposed under the water tank to collect condensed water generated in the heat exchange module; a tank drawer in which the water tank is accommodated, the tank drawer being slidably disposed on the main body; a frame supporting the heat exchange module, the frame partitioning a space in which the tank drawer is accommodated from a space in which a compressor is provided; a main guide disposed on each of both sides of the frame to guide the slidable insertion/withdrawal of the tank drawer; and a sub guide disposed on each of both sides of the frame to accommodate a rotation protrusion that protrudes from each of both side surfaces of the tank drawer, the sub guide guiding slidable movement and rotation of the rotation protrusion.

A rack gear may be disposed on a top surface of the main guide in a direction in which the tank drawer is withdrawn, and a pinion gear coupled to the rack gear to move along the main guide may be disposed on the tank drawer.

A driving motor for rotating the pinion gear may be further provided on the tank drawer.

The main guide may include: a horizontal part extending in a front/rear direction in which the tank drawer is inserted and withdrawn; and a rotation part, which is tilted or rounded to guide the rotation of the tank drawer, extending from an end of the horizontal part.

The dehumidifier may further include: a guide member disposed above a rotation shaft of the tank drawer to protrude from each of both left and right surfaces of the tank drawer; and a guide hole passing through the main guide to allow the guide member to be inserted therein, thereby guiding the movement of the guide member.

A tilted part that is tilted so that the tank drawer is withdrawn forward by a self-weight thereof may be further disposed on a bottom surface of the tank drawer.

A main body support extending downward to prevent the dehumidifier from falling down onto the ground when a center of gravity of the tank drawer moves due to the withdrawal of the tank drawer may be further disposed on a base plate defining a bottom surface of the dehumidifier.

A rotation shaft of the tank drawer may be disposed at a rear side of the center of gravity of the tank drawer.

A locker and latch which are selectively hooked with each other to maintain a closed state of the tank drawer may be disposed on the tank drawer and the frame, respectively.

In another embodiment, a dehumidifier includes: a main body in which a heat exchange module is disposed; a water tank disposed under the water tank to collect condensed water generated in the heat exchange module; a tank drawer in which the water tank is accommodated, the tank drawer being slidably disposed on the main body; a frame supporting the heat exchange module, the frame partitioning a space in which the tank drawer is accommodated from a space in which a compressor is provided; a drawer frame rotatably coupled to a rotation shaft disposed on each of both side surfaces of the tank drawer so that the tank drawer is rotatably supported; and a guide rail connecting the frame to the drawer frame, the guide rail extending in multi stages so that the tank drawer is slidably inserted and withdrawn, wherein the rotation shaft rotates after being slidably withdrawn, and when the rotation shaft rotates, a top surface of the water tank is completely exposed.

A rack gear extending in a front/rear direction may be disposed on each of both left and right sides of the frame, and a pinion gear coupled to the rack gear to move along the rack gear may be disposed on an inserted/withdrawn portion of the guide rail.

The guide rail may include: a fixed rail fixed to the frame; and a movable rail inserted and withdrawn along the fixed rail, the movable rail being coupled to the drawer frame, wherein the pinion gear may be rotatably mounted on the movable rail.

A guide protrusion protruding from a side that is away from the rotation shaft may be disposed on the tank drawer, and a tilting guide hole that is opened along a moving trace of the guide protrusion when the tank drawer rotates to accommodate the guide protrusion may be further provided in the drawer frame.

A tilted part that is tilted so that the tank drawer is withdrawn forward by a self-weight thereof may be further disposed on a bottom surface of the tank drawer.

A main body support extending downward to prevent the dehumidifier from falling down onto the ground when a center of gravity of the tank drawer moves due to the withdrawal of the tank drawer may be further disposed on a base plate defining a bottom surface of the dehumidifier.

The rotation shaft of the tank drawer may be disposed at a rear side of the center of gravity of the tank drawer.

A locker and latch which are selectively hooked with each other to maintain a closed state of the tank drawer may be disposed on the tank drawer and the frame, respectively.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A dehumidifier comprising:
a main body in which a heat exchange module is provided;
a water tank under the heat exchange module to collect condensed water from the heat exchange module;
a tank drawer to accommodate the water tank, the tank drawer to be slidably provided at the main body;
a frame to support the heat exchange module, the frame to partition a first space to accommodate the tank drawer from a second space to provide a compressor;
a main guide on first and second surfaces of the frame to guide the tank drawer when the tank drawer is moved inward and when the tank drawer is moved outward; and
a sub guide on the first and second sides of the frame to accommodate a rotation protrusion that protrudes from each of first and second surfaces of the tank drawer, the sub guide to guide slidable movement and rotation of the rotation protrusion at the tank drawer.

2. The dehumidifier according to claim 1, wherein the main guide includes a rack gear is provided in a direction in which the tank drawer is moved outward, and the dehumidifier further comprises:
a pinion gear, at the tank drawer, to be provided at the rack gear and to move along the main guide.

3. The dehumidifier according to claim 2, further comprising a driving motor to rotate the pinion gear.

4. The dehumidifier according to claim 1, wherein the main guide includes:
a horizontal part extending in a direction corresponding to inward movement of the tank drawer and outward movement of the tank drawer; and
a rotation part extending from the horizontal part, the rotation part to guide rotation of the tank drawer.

5. The dehumidifier according to claim 1, wherein a guide member to protrude from each of the first and second surfaces of the tank drawer, and the main guide to include a guide hole to allow the guide member to be inserted therein, and to thereby guide movement of the guide member.

6. The dehumidifier according to claim 1, wherein the tank drawer includes a tilted part to allow the tank drawer to tilt such that the tank drawer is moved outward by a self-weight.

7. The dehumidifier according to claim 1, further comprising:
a main body support extending downward to prevent the dehumidifier from falling down when the tank drawer is moved outward; and
a base plate to define a bottom of the dehumidifier.

8. The dehumidifier according to claim 1, wherein the tank drawer includes a rotation shaft at a rear of the tank drawer.

9. The dehumidifier according to claim 1, further comprising a locker and a latch to selectively connect with each other to maintain a closed state of the tank drawer, the locker provided at one of the tank drawer and the frame, and the latch provided at the other one of the tank drawer and the frame.

10. A dehumidifier comprising:
a main body in which a heat exchange module is provided;
a water tank under the heat exchange module to collect condensed water from the heat exchange module;
a tank drawer to accommodate the water tank, the tank drawer to be slidably provided at the main body;
a frame to support the heat exchange module, the frame to partition a first space to accommodate the tank drawer from a second space to provide a compressor;
a drawer frame to rotatably couple to a rotation shaft at each of first and second surfaces of the tank drawer such that the tank drawer is rotatably supported; and
a guide rail to couple the frame to the drawer frame, the guide rail to extend in a plurality of stages such that the tank drawer is moved inward and the tank drawer is moved outward,
wherein when the tank drawer is moved outward, the tank drawer to rotate about the rotation shaft, and to expose a top surface of the water tank.

11. The dehumidifier according to claim 10, wherein the frame includes a rack gear on each of first and second surfaces of the frame, and
a pinion gear, at the guide rail, to be provided at the rack gear and to move along the rack gear.

12. The dehumidifier according to claim 11, wherein the guide rail includes:
a fixed rail to attach to the frame; and
a movable rail to move along the fixed rail, the movable rail to couple to the drawer frame,
wherein the pinion gear is to be rotatably provided at the movable rail.

13. The dehumidifier according to claim 10, wherein the tank drawer includes a guide protrusion to protrude from a surface of the tank drawer, and
the drawer frame includes a tilting guide hole to receive the guide protrusion when the tank drawer rotates.

14. The dehumidifier according to claim 10, wherein the tank drawer includes a tilted part to allow the tank drawer to tilt such that the tank drawer is moved outward by a self-weight.

15. The dehumidifier according to claim 10, further comprising:
a main body support extending downward to prevent the dehumidifier from falling down when the tank drawer is moved outward; and
a base plate to define a bottom of the dehumidifier.

16. The dehumidifier according to claim 10, wherein the tank drawer includes the rotation shaft at a rear of the tank drawer.

17. The dehumidifier according to claim 10, further comprising a locker and a latch to selectively connect with each other to maintain a closed state of the tank drawer, the locker provided at one of the tank drawer and the frame, and the latch provided at the other one of the tank drawer and the frame.

18. A dehumidifier comprising:
a body;
a water tank to collect water from a heat exchange device provided at the body;
a tank drawer to accommodate the water tank, the tank drawer to be slidably provided;
a frame to support the heat exchange device;
a first guide on a first side of the frame to guide the tank drawer;
a second guide on a second side of the frame to guide the tank drawer;
a first sub guide on the first side of the frame to accommodate a first rotation protrusion that protrudes from a first side of the tank drawer; and
a second sub guide on the second side of the frame to accommodate a second rotation protrusion that protrudes from a second side of the tank drawer.

19. The dehumidifier according to claim 18, wherein the first guide includes a first rack gear, and the second main guide includes a second rack gear, and a first pinion gear to couple to the first rack gear and to move along the first main guide.

20. The dehumidifier according to claim 18, wherein the guide includes:
a horizontal part extending in a direction corresponding to inward movement of the tank drawer and outward movement of the tank drawer; and
a rotation part extending from the horizontal part, the rotation part to guide rotation of the tank drawer.
